(19) United States
(12) Patent Application Publication
(10) Pub. No.: US 2019/0267648 A1
(43) Pub. Date: Aug. 29, 2019

(54) DETERMINING THE STATE OF CHARGE OF AN ALL-VANADIUM REDOX FLOW BATTERY USING UV/VIS MEASUREMENT

(71) Applicants: thyssenkrupp Industrial Solutions AG, Essen (DE); thyssenkrupp AG, Essen (JP)

(72) Inventors: Stefan HELMLE, Hamm (DE); Niels BREDEMEYER, Waltrop (DE); Gregor Damian POLCYN, Dortmund (DE); Nils TENHUMBERG, Dortmund (DE)

(73) Assignees: thyssenkrupp Industrial Solutions AG, Essen (DE); thyssenkrupp AG, Essen (DE)

(21) Appl. No.: 16/333,292

(22) PCT Filed: Sep. 8, 2017
(86) PCT No.: PCT/EP2017/072547

§ 371 Date: Mar. 14, 2019

(30) Foreign Application Priority Data
Sep. 19, 2016 (DE) 10 2016 117 604.4

(51) Int. Cl. H01M 8/0444; H01M 8/18; H01M 8/04186; H01M 8/04082

(52) U.S. Cl. CPC H01M 8/04477; H01M 8/04201; H01M 8/04186; H01M 8/188

(57) ABSTRACT

A method for determining a charge state of a vanadium redox flow cell may comprise indirectly determining concentrations of V⁴⁺ and V⁵⁺ in a positive electrolyte by mixing positive and negative electrolytes with one another in particular proportions to reduce V⁵⁺ present in the positive electrolyte. In this way, CT complexes of V⁴⁺/V⁵⁺ may be avoided, the concentration of which is not determinable directly owing to the strong UV/vis absorption. Furthermore, the method enables determination of the concentrations of the negative electrolyte and positive electrolyte via UV/vis absorptions, which enables simple monitoring of the charge state of a vanadium redox flow battery.

### CROSS REFERENCE TO RELATED APPLICATIONS

This application is a U.S. National Stage Entry of International Patent Application Serial Number PCT/EP2017/072547, filed Sep. 8, 2017, which claims priority to German Patent Application No. DE 10 2016 117 604.4, filed Sep. 19, 2016, the entire contents of both of which are incorporated herein by reference.

### FIELD

The present disclosure generally relates to vanadium redox flow batteries, methods for operating a vanadium redox battery, and methods for determining a charge state of a vanadium redox flow battery with the aid of concentration measurements of a negative electrolyte and a positive electrolyte by UV/vis spectrometry.

### BACKGROUND

With rising awareness of environmental protection and the high fuel prices that are to be expected in the future, energy companies and governments globally have developed an increased interest in renewable energies that are generated via oceanic sources or tides, geothermal power plants, wind power plants and solar cells. Owing to the inconstancy of the electrical energy generated predominantly from renewable energies, however, it is necessary to provide additional storage systems for such fluctuating energies—for example in the form of electricity from photovoltaic or wind power plants—in which excess electrical energy can be stored or with which electrical grids can be stabilized. For instance, electrical energy can be stored in such storage systems in periods in which more electrical energy is generated than is consumed in order to avoid overloading of the power grids. At a later juncture, when more energy is required than can be provided by the renewable energies, the energy can then be fed back into the electrical power grid.

Many energy storage systems used nowadays are redox flow batteries. By contrast with conventional batteries, the electrodes of a redox flow battery are incorporated solely in a catalysis process, but not in chemical reactions, such that the electrode is not consumed or enlarged in the course of use of the storage system. The energy-storing reactants—the redox pair in the electrolyte—are instead stored in reservoir vessels and introduced when required into an electrochemical cell (hence the term “flow”), in which they are subjected to oxidation and reduction reactions. When required, the chemical energy thus stored in the electrolyte can then be converted back to electrical energy in that the electrochemically active redox pairs are returned to the cell from the tanks and subjected to the reverse reaction. On account of their flexible dimensioning options and low maintenance demand, redox flow batteries are particularly suitable for temporary energy storage.

Redox flow batteries based on various redox pairs are known. For instance, the positive electrolyte used in some cases is iron solutions with the Fe²⁺/Fe³⁺ redox pair, while the negative electrolyte is based on chromium solutions with the Cr²⁺/Cr³⁺ redox pair (cf., for example, U.S. Pat. No. 4,159,366). The vanadium redox flow battery (VRB) has the advantage over such batteries that the redox pairs in the negative electrolyte and positive electrolyte are based on the same element, vanadium, which can exist in di-, tri-, tetra- and pentavalent form. In most vanadium redox flow batteries, the di- and trivalent form are present as V²⁺ and V³⁺ ions, while the tetra- and pentavalent form are present as VO²⁺ and VO₂⁺. This has advantages in relation to rapid response time, lack of contamination in the event of a membrane defect, flexible design and high cycle number. For these reasons, vanadium redox flow batteries are especially suitable for use as large-scale energy storage means.

In the operation of vanadium redox flow batteries, the monitoring of the charge state and of the vanadium concentration or of the molar amount of vanadium in the positive electrolyte and the negative electrolyte is of crucial importance. The reason for the monitoring of the charge state is that overcharging of the battery should be very substantially avoided since overcharging results in electrolytic splitting of water, and so hydrogen gas and oxygen gas are generated in the cells. Moreover, in the event of overloading, the efficiency is reduced since energy fed in is consumed predominantly for the side reactions. Complete discharge of the battery (i.e. to an SOC=state of charge <5%) should also be avoided since there can otherwise be aging of the electrolyte. For the operation of a redox flow battery, it is therefore necessary that the charge state is determined at certain time intervals and preferably continuously in order to avoid excessive discharge or overcharging of the battery.

The reason for the monitoring of the vanadium concentration or molar amount of vanadium in the two electrolyte tanks is that various processes that proceed during the long-term operation of redox flow batteries can lead to a change in the vanadium concentration, in the molar amount of vanadium or in the charge state in the two electrolytes. These processes can likewise lead to a shift in the electrolyte volume between the two electrolytes.

The phenomena described are attributable mainly to the mass transfer of vanadium ions and water through the membrane. The diffusion of vanadium ions through the membrane is referred to as vanadium crossover. The consequence of this vanadium crossover is a shift in the vanadium concentration or the molar amount of vanadium in the two electrolyte tanks and partial self-discharge of the electrolyte. The diffusion of water through the membrane can lead to a shift in the vanadium concentration and the electrolyte volumes. This can lead to a higher vanadium concentration on one half-cell side of the battery and to a decrease in the vanadium concentration on the other half-cell side of the battery. This results in an imbalance in the vanadium concentration or molar amount and in the state of charge (SoC) in the two electrolytes and in a low capacity of the storage means. The loss of capacity of the battery can be determined with reference to the vanadium concentration or molar amount of vanadium and the charge state of the negative electrolyte and the positive electrolyte.

In order to restore the original capacity of the storage means, rebalancing or remixing of the electrolyte is necessary at certain time intervals in order to rebalance the different molar amounts, concentration, volume and/or charge states of the two electrolytes. However, the rebalancing leads to partial discharge of the electrolyte, and remixing generally to complete discharge of the electrolyte. Both rebalancing and remixing have an adverse effect on the energy efficiency of the redox flow battery.

Unambiguous determination of the concentration of the individual di- to pentavalent vanadium species in vanadium redox flow batteries, referred to in the present document, for the sake of simplicity and irrespective of the ion/complex actually present, as V²⁺, V³⁺, V⁴⁺ and V⁵⁺, although V⁴⁺ and V⁵⁺ may not be present as such but, for example, in the form of VO²⁺ and VO₂⁺, is necessary for the following further reasons as well:
V²⁺ is a strong reducing agent and is gradually oxidized to V³⁺ in the presence of traces of oxygen;
V⁵⁺ is stable only within a limited temperature window and concentration range and can age and precipitate irreversibly out of the solution over time;
in operation, a small amount of water can be constantly discharged, which has to be replaced again periodically.

All the above-described processes lead to a change in concentration both in the positive electrolyte and in the negative electrolyte that results in distortion of the charge state measured when test methods that are not independent of the total vanadium concentration are used.

The offline standard analysis employed for the determination of the concentrations of V²⁺, V³⁺ and V⁴⁺ is a permanganometric titration, in which the charge state both of the negative electrolyte and in some cases of the positive electrolyte can be ascertained via the various equivalence points of V²⁺, V³⁺ and V⁴⁺. In the case of the negative electrolyte, direct titration is effected here, the oxidation of V²⁺ being kinetically inhibited. The charge state of the positive electrolyte is determined for V⁵⁺ via a back-titration. However, a disadvantage of this analysis technique is that the measurement cannot be conducted online (i.e. in continuous operation); instead, samples have to be taken from the positive electrolyte and from the negative electrolyte, and these then have to be subjected to the permanganometric titration. For this reason, permanganometric titration cannot be used for constant monitoring of the charge state of a redox flow battery.

The charge state during operation is therefore nowadays frequently determined using conductivity sensors for the electrolytes. This makes use of the fact that ions have a specific molar ion conductivity via which the concentrations of these ions can be determined. An empirical model that additionally takes account of the effect of temperature on conductivity is known in the literature (S. Corcuera and M. Skyllas-Kazacos, Eur. Chem. Bull. 2012, 1(12), 511-519). However, the main problem with conductivity measurement is that unambiguous determination of the individual ion concentrations (i.e. V²⁺ and V³⁺ for the negative electrolyte and V⁴⁺ and V⁵⁺ for the positive electrolyte) requires the total concentration (Vₜₒₜ and SO₄²⁻) to remain constant. However, this cannot be assured in normal operation since the above-described processes, i.e. particularly diffusion processes or possible irreversible precipitation of V⁵⁺ (as V₂O₅) out of the solution result in occurrence of a change in the total concentration of vanadium and sulfate. This could effectively, for example, in a drift in the conductivity to higher values in the case of the negative electrolyte and lower values in the case of the positive electrolyte with rising number of charge and discharge cycles. For these reasons, the determination of the charge state with the aid of conductivity sensors is possible only with low accuracy.

An alternative for determination of the charge state is correlation via density and/or viscosity of the electrolyte in the two half-cells. However, a disadvantage in this mode of determination is likewise the only limited accuracy.

A further method of determining the charge state is the measurement of the redox potential since there is a direct correlation between concentration of the individual ion types and voltage. Here too, however, via the Nernst equation, there is an indirect dependence on the total vanadium concentration in such a way that there is a change, for example, in the coefficient of activity and hence in the redox potential.

For online measurements, optical methods in particular are a frequently used approach. For example, there is a description of the use of an IR detector in the NIR region (950 nm) (S. Rudolph et al., J. Electroanal. Chem. 2013, 694, 17-22). However, this is restricted to use for determination of the concentration in the negative electrolyte because, in the case of the positive electrolyte, owing to the strong absorption of the generally 1.6 molar solution (based on the total vanadium concentration), transmission is detectable only in the case of a charge state of below about 5% or above 95%. Thus, it is not possible to work with the aid of this method within the actual use range of the battery (SOC in the range from 5 to 95%).

The use of electromagnetic rays in the UV/vis region has been proposed and extensively described in the literature for determination of the charge state of redox flow batteries (L. Liu et al., J. App/Electrochem, 2012, 42, 1025-1031; N. Buckley et al., J. Electrochem. Soc., 2014, 161, A524-A534 and others). For this purpose, calibration lines are first to be recorded at about 400 nm, about 600 nm and/or about 800 nm, which are to be used to determine the redox state on the basis of the linear relationship between absorption and charge state. However, the evaluation is made more difficult for the positive electrolyte in that a divalent dinuclear complex of V⁴⁺ and V⁵⁺ is formed, which has high absorption owing to intense CT bands.

The literature also describes various approaches for determination of the charge states of the positive electrolyte. In a first approach, the transmission spectra of the various charge states are to be recorded at known total vanadium and sulfuric acid concentration and used as comparative spectra for calibration. In another approach, the “excess” absorption at a defined wavelength (e.g. 760 nm), after subtraction of the expected spectra for V⁴⁺ and V⁵⁺, is to be plotted against the charge state. The parabolic function that results from this plot can then be fitted using a second-order polynomial. But both approaches to a solution are extremely difficult to implement for different reasons. The first solution with comparative spectra is relatively inexact and requires considerable investment in computation and work. Moreover, it is unlikely to be practicable owing to the strong absorption of dinuclear V⁴⁺/V⁵⁺ complexes at total vanadium concentrations of about 1.6 M and higher concentrations where vanadium redox flow batteries are normally operated. In the second approach, the difficulty arises that exact knowledge of the equilibrium constants and the extinction coefficient for the divalent dinuclear complex is required. In preliminary studies for this application, however, it was found that the equilibrium constant has to be corrected by the activity of the solution, which is known to be concentration-dependent. As a result, the determination of the equilibrium constants and of the extinction coefficient cannot be implemented with sufficient accuracy specifically at high concentrations.

A patent publication by Buckley et al. (WO 2015/082475) describes an approach that works with comparison graphs, calibration functions and approximation methods to ascertain the charge state of the flow cell. However, by this method as well, the determination of the charge state is associated with high time demands and is not usable in this way as an online measurement owing to the approach. The results are additionally relatively inexact, and so the conclusion as to individual concentration and total concentration for at least the positive electrolyte is rated as unsatisfactory.

The literature described various approaches for rebalancing. Rebalancing, or the compensation of the volume of the two electrolytes, is often conducted via an overflow between the two electrolyte tanks. This method of rebalancing has the disadvantage that only compensation of the volume of the negative electrolyte and the positive electrolyte takes place. There is no compensation of the electrolytes with regard to the vanadium concentration and/or the molar amount of vanadium in the two electrolytes.

Rudolph et al. [S. Rudolph, U. Schroder, I. M. Bayanov, On-line controlled state of charge rebalancing in vanadium redox flow battery, Journal of Electroanalytical Chemistry 2013, 703, 29] describe a method of rebalancing the H⁺ ion concentration. In this method, a small volume (5 ml) of the negative electrolyte is introduced into the positive electrolyte every four cycles. The same volume of the positive electrolyte is introduced into the negative electrolyte. In order to keep the self-discharge of the battery as low as possible, the rebalancing is conducted in the discharged state.

In a patent publication, Perry et al. [M. L. Perry, A. Smeltz, X. Wei, Rebalancing electrolyte concentration in flow battery using pressure differential, WO 2015/099728 A1 (2013), 2013] describe a method of rebalancing the electrolyte concentration by pumping the two electrolytes through the two half-cells at different flow rates and hence generating a pressure differential between the two half-cells. Owing to osmotic effects, the effect of a higher pressure in the negative half-cell is that the solvent (H₂O) diffuses through the membrane from the negative electrolyte into the positive electrolyte. This dilutes the positive electrolyte in the positive half-cell and concentrates the negative electrolyte.

The methods described have the disadvantage that the rebalancing is conducted via the electrolyte tanks or in the cell, and the self-discharge of the electrolyte takes place in the electrolyte tanks or in the cell. However, the volume flows used for rebalancing are not used for the further analysis of the electrolyte.

Thus a need exists for methods by which the individual ion concentrations of di- to pentavalent vanadium reported as (V2+ to V5+) and hence the charge state both of the negative electrolyte and the positive electrolyte can be determined with sufficient accuracy in a vanadium redox flow battery. Moreover, a need exists for such methods to require a minimum level of additional work such as, for example, the performance of calibrations, the determination of calibration lines, or approximation methods.

### BRIEF DESCRIPTION OF THE FIGURES

FIG. 1 is a schematic diagram of an example battery.

FIG. 2 is a graph depicting extinction coefficients of the di- and tri-vanadium species.

FIG. 3 is a graph depicting extinction coefficients of the tetravalent vanadium species.

FIG. 4 is a graph for iterative determination of the extinction coefficients of a negative electrolyte system via a series of real samples with different total vanadium concentrations and charge states.

FIG. 5 is a graph similar to the graph of FIG. 4, but is based on different real samples with different total vanadium concentrations and charge states and a mixing ratio of 1.5 parts positive electrolyte to 1 part negative electrolyte.

FIG. 6 is a graph depicting wavelength versus absorption wherein the charge state and the total vanadium concentration of a negative electrolyte solution were determined by means of the UV/vis spectrum.

FIG. 7 is graph depicting wavelength versus absorption for a semicharged state of a redox flow battery wherein the charge state and the total vanadium concentration of a negative electrolyte solution were determined by means of the UV/vis spectrum.

FIG. 8 is a graph depicting UV/vis spectra that were employed for evaluation.

FIG. 9 is another graph depicting UV/vis spectra that were employed for evaluation.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

As explained above, the present disclosure generally relates to methods of determining the charge state of a vanadium redox flow battery with the aid of concentration measurements of the negative electrolyte and positive electrolyte by UV/vis spectrometry, as well as to methods of operating a vanadium redox battery. The charge state of the redox flow battery may be determined with the aid of the disclosed methods. The present disclosure further relates to vanadium redox flow batteries equipped with devices that allow for the determination of the charge state with reference to the UV/vis absorptions of the negative electrolyte and positive electrolyte using UV/vis measurements and, by virtue of these devices, avoid or reduce the need for rebalancing.

In a first aspect, the present invention therefore relates to a method of determining the charge state of a vanadium redox flow battery having a negative half-cell and a positive half-cell, comprising the steps of
(i) determining the charge state of the negative electrolyte by determining the concentrations of V²⁺ and V³⁺ via absorption at a defined wavelength,
(ii) mixing a defined volume of the negative electrolyte and the positive electrolyte,
(iii) determining the concentrations of V²⁺ and V³⁺ or V³⁺ and V⁴⁺ via absorption at a defined wavelength in the mixture of negative electrolyte and positive electrolyte, and
(iv) determining the charge state of the positive electrolyte by calculating the original concentrations of V⁴⁺ and V⁵⁺ from the concentrations determined in steps (i) and (iii).

The method of the invention is accordingly based on an optical method by which extremely precise determination of the concentration of the individual vanadium species and hence of the charge state is possible.

A second aspect of the present invention relates to a method of operating a vanadium redox flow battery, in which the charge state of the battery is determined by
(i) determining the charge state of the negative electrolyte by determining the concentrations of V²⁺ and V³⁺ via absorption at a defined wavelength,
(ii) mixing a defined volume of the negative electrolyte and the positive electrolyte,
(iii) determining the concentrations of V²⁺ and V³⁺ or V³⁺ and V⁴⁺ via absorption at a defined wavelength in the mixture of negative electrolyte and positive electrolyte, and
(iv) determining the charge state of the positive electrolyte by calculating the original concentrations of V⁴⁺ and V⁵⁺ from the concentrations determined in steps (i) and (iii).

The method outlined above can be conducted offline by taking samples of the positive electrolyte and negative electrolyte at particular time intervals and subjecting them to the method steps specified. In the context of the present invention, however, it is preferable when the process is conducted online, meaning that the charge state of the battery is determined in the course of operation of the battery and the negative electrolyte and positive electrolyte remain within the battery during the measurement. This can easily be implemented, for example, in the case of the negative electrolyte by feeding a portion of the negative electrolyte that is fed to the redox flow battery through a UV/vis detector.

The attribute “UV/vis” in the context of the present invention denotes the wavelength range from 200 to 1000 nm.

The negative electrolyte contains vanadium ions essentially (i.e. to an extent of more than 99%) in the +II and +III oxidation states, while the positive electrolyte contains vanadium ions essentially (i.e. to an extent of more than 99%) in the +IV and +V oxidation states.

The vanadium redox flow battery may consist of one or more cells, each of these cells comprising a half-cell having negative electrolyte and a half-cell having positive electrolyte. The negative and positive half-cells are not fixed; in other words, depending on how the battery is charged, one of the half-cells becomes the positive half-cell and one of the half-cells the negative half-cell.

The attribute “defined volume” should be interpreted such that the volumes of the negative electrolyte and the positive electrolyte are defined externally (i.e. via the control of the battery/cell) and are kept constant for a number of measurements.

In relation to the total vanadium concentration, it is appropriate for the negative and positive half-cells specified when it is within the range from 0.5 to 8 mol/L, preferably 1 to 3 mol/L, more preferably 1.2 to 2.5 mol/L. If the total vanadium concentration falls, the total storage capacity of the vanadium redox flow battery at constant volume of the two electrolyte tanks is reduced. At a total vanadium concentration of more than 8 mol/L, by contrast, there is the disadvantage that the electrolytic solution is of relatively high viscosity, which leads to elevated resistance in flow through the cell and to reduced conversion effectiveness in the cells.

For the negative electrolyte, the determination of the V²⁺ concentration is appropriately conducted at a wavelength in the range from 800 to 900 nm, preferably 840 to 865 nm and more preferably at about 852 nm. This wavelength has the advantage that there is very substantially no interference with the bands of the V³⁺ species. For the determination of the V³⁺ concentration, by contrast, it is preferable when this is conducted by measuring the absorption at a wavelength in the range from 370 to 450 nm, preferably 390 to 415 nm and more preferably at about 402 nm. Alternatively, albeit less preferably, the V³⁺ concentration can also be determined by measuring the absorption in the range from 550 to 700 nm, preferably 605 to 630 nm and most preferably about 612 nm.

By contrast with the methods described in the prior art, it is not necessary within the scope of the method of the present invention to conduct a calibration, and so the methods described preferably do not have any calibration step. Instead, the concentrations are determined by determining the extinction coefficient of the individual species at the relevant wavelengths, which is a constant. The extinction coefficients can therefore be used in combination with the measured absorption to calculate the concentration of the vanadium species. According to the Lambert-Beer law, the path length is used to calculate the concentration of the individual species:

$$A = ɛ \cdot c \cdot d$$

$$c = \frac{A}{ɛ \cdot d}$$

with c=concentration of the species to be determined (in mol/L), A=absorption value at a particular wavelength λ, ε=molar extinction coefficient of the species and d=path length.

Specifically, the concentrations can be determined by employing, for example, the maximum at 852 nm for determination of the concentration of V²⁺, whereas, for V³⁺, owing to the only slight interference by the V²⁺ band at around 370 nm, the maximum at 402 nm is an option.

Within the scope of the methods described above, it may be advisable if, for optimization, the absorption ascertained in each case is corrected by the absorption component of the respective other species. Equations 1 and 2 that arise therefrom can be solved exactly by means of linear algebra and hence the concentration of V²⁺ and V³⁺ can be determined. The ratio of the V²⁺ concentration to the total vanadium concentration (V²⁺ and V³⁺) can thus be used to ascertain the charge state of the negative electrolyte by formula 3.

$$\begin{matrix}at 852 nm \text{:} {c}_{{V}^{2 +}} = \frac{{A}_{{V}^{2 +} ; 852} - {A}_{{V}^{3 +} ; 852}}{{ɛ}_{{V}^{2 +} ; 852} \cdot d} \\ with {A}_{{V}^{3 +} ; 852} = {c}_{{V}^{3 +}} \cdot {ɛ}_{{V}^{3 +} ; 852} \cdot d & ( 1 ) \\ at 402 nm \text{:} {c}_{{V}^{3 +}} = \frac{{A}_{{V}^{2 +} ; 402} - {A}_{{V}^{3 +} ; 402}}{{ɛ}_{{V}^{3 +} ; 402} \cdot d} \\ with {A}_{{V}^{3 +} ; 402} = {c}_{{V}^{3 +}} \cdot {ɛ}_{{V}^{3 +} ; 402} \cdot d & ( 2 ) \\ SOC [ \% ] = \frac{[ {V}^{2 +} ]}{[ {V}^{2 +} + {V}^{3 +} ]} & ( 3 )\end{matrix}$$

There are three conceivable methods for determining the charge state of the positive electrolyte. For instance, the positive electrolyte can be measured directly without dilution, but this leads to the problems outlined at the outset. The solution of the positive electrolyte, owing to the very high extinction coefficient of the divalent dinuclear complex in the region of about 1500-2500 L mol⁻¹ cm⁻¹, given a standard concentration of about 1.6 mol/L, is so intensely colored that a cuvette path length of not more than 10 μm would have to be used for the absorption not to exceed the technically defined measurement range. At path length 10 μm, however, even the smallest amounts of solid particles can lead to blockage of the cell. A further problem, moreover, is the determination of the concentrations of the individual vanadium species. Although it is probably possible, after determining the extinction coefficient and the equilibrium constants for formation of the nuclear complex (and if necessary determining the coefficients of activity) to determine the concentration via an iterative method, this would entail significant investment in computation and software.

A second approach is to dilute the positive electrolyte, for example by a factor of 1 to 2, and to analyze the resulting solution in a cuvette with a path length of 100 μm. However, this option does not get around the aforementioned problem of investment in computation and software either. Furthermore, this solution requires exact dilution since any inaccuracy, owing to the high extinction coefficient, has a significant influence on the measurement accuracy. A further problem is additionally that the solution would be diluted and could probably not be recycled back into the circuit.

The problem of determining the charge state of the positive electrolyte is therefore solved in accordance with the invention by mixing a defined volume of the negative electrolyte and of the positive electrolyte with one another, the effect of which is that reaction of V²⁺ in the negative electrolyte and V⁵⁺ in the positive electrolyte, depending on the concentration of the respective species, generates V³⁺ ions and/or V⁴⁺ ions. The same is true of the reaction of V³⁺ with V⁵⁺ and V²⁺ with V⁴⁺. Subsequently, the concentration of V²⁺ and V³⁺ or V³⁺ and V⁴⁺ ions in the resulting mixture of the negative electrolyte and positive electrolyte is determined again by absorption at a defined wavelength in the mixture of negative and positive electrolytes, and reference may be made to the above remarks in relation to the wavelength to be used for determination of the concentrations of V²⁺ and V³⁺. Whether, and in what way, V²⁺ and V³⁺ or V³⁺ and V⁴⁺ ions form as a result of mixing of the two electrolytes is dependent solely on the mixing ratio, the charge states and the total vanadium concentration of the individual electrolytes. The only thing that should be avoided is that V⁵⁺ species are still present after the mixing. The concentration of V⁴⁺ is preferably determined at a wavelength in the range from 700 to 850 nm, preferably 760 to 785 nm and more preferably at 773 nm, since V⁴⁺ species have their maximum absorption within this range.

Since V³⁺ ions have a high absorption at a wavelength of about 402 nm, whereas in V⁴⁺ ions do not absorb in this region, the absorption of V³⁺ at a wavelength of 773 nm can be determined from the V³⁺ concentration and the extinction coefficient at this wavelength and taken into account in the calculation of the V⁴⁺ concentration.

Within the scope of the methods outlined, it is appropriate if the ratio in which the negative electrolyte and the positive electrolyte are mixed with one another in step (ii) is in the range from 4:1 to 1:4, and a ratio of 3:1 to 1:3 may be specified as preferred. It is not important here at first which electrolyte is used in a greater proportion and which in a lesser proportion. What is crucial in this procedure is instead that the mixing of the two electrolytes results in a redox reaction that ensures that any V⁵⁺ is reduced. The remaining vanadium species are thus either V⁴⁺ and V³⁺ (ratio of positive electrolyte to negative electrolyte, for example, 2:1) or V³⁺ and V²⁺ (ratio of positive electrolyte to negative electrolyte >1:2 with an assumed SOC of 100% and equal total vanadium concentrations of the electrolytes). This procedure gets round the aforementioned problems of excessively high extinction, short cuvette path length, and investment on computation and software. It is most preferred when the ratio in which the negative electrolyte and the positive electrolyte are mixed with one another in step (ii) is about 2:1 or about 1:2.

For the calculation of the concentrations of V⁴⁺ and V³⁺, it is also appropriate to conduct a correction by the absorption component of the vanadium ion of the respective other oxidation state. The V⁴⁺ and V³⁺ concentrations can then be calculated, for example, via the following formulae (4) and (5) and solution of the linear equation system.

$$\begin{matrix}at 773 nm \text{:} {c}_{{V}^{2 +}} = \frac{{A}_{{V}^{2 +} ; 773} - {A}_{{V}^{3 +} ; 773}}{{ɛ}_{{V}^{2 +} ; 773} \cdot d} \\ with {A}_{{V}^{3 +} ; 773} = {c}_{{V}^{3 +}} \cdot {ɛ}_{{V}^{3 +} ; 352} \cdot d & ( 4 ) \\ at 402 nm \text{:} {c}_{{V}^{3 +}} = \frac{{A}_{{V}^{2 +} ; 402} - {A}_{{V}^{3 +} ; 402}}{{ɛ}_{{V}^{3 +} ; 402} \cdot d} \\ with {A}_{{V}^{3 +} ; 402} = {c}_{{V}^{3 +}} \cdot {ɛ}_{{V}^{3 +} ; 402} \cdot d & ( 5 )\end{matrix}$$

Back-calculation to determine the actual V⁴⁺ and V⁵⁺ concentrations in the positive electrolyte are effected via a semiempirical formula that takes account of the ascertained concentrations of the V³⁺ and V⁴⁺ concentrations of the mixture of positive and negative electrolytes and of the V²⁺ and V³⁺ concentrations of the negative electrolyte used for the mixture.

If the mixing of the positive electrolyte and negative electrolyte affords solely V²⁺ and V³⁺ ions, the concentration of these ions is determined by the above-described formulae (1) and (2) and said semiempirical formula.

The above-described method of operating a vanadium redox flow battery can advantageously be further configured in that the charge state of the negative electrolyte is determined firstly upstream of the feed to the electrolysis cell and secondly in the region of the outlet from the electrolysis cell. This approach has the advantage that, as well as the charge state, it is also possible to determine the charge efficiency or discharge efficiency of the electrolysis cell. In addition, it is appropriate when steps (ii) to (iv) are also conducted with positive electrolyte and negative electrolyte, each of which are branched off upstream of the feed to the electrolysis cell and in the region of the outlet from the electrolysis cell. The determination of the charge state of the positive electrolyte in steps (ii) to (iv) can thus also be used to determine the charge efficiency or discharge efficiency of the positive electrolysis cell.

In the course of steps (ii) to (iv), a mixture of positive electrolyte and negative electrolyte is generated, which, because of the fact that vanadium redox flow batteries have essentially the same chemical elements in the positive electrolyte and negative electrolyte, can be fed back to the electrolyte circuits. Although this has the result that, owing to the discharge of the positive electrolyte and negative electrolyte for technical reasons as a result of the determination of the charge state, a small amount of additional energy is required to fully recharge the vanadium redox flow battery, this disadvantage is compensated for in that the recycling of the electrolyte can keep the total storage capacity of the vanadium redox flow battery constant. If, within the scope of the method, the positive electrolyte and negative electrolyte are mixed in a particular ratio, it is additionally appropriate if the mixture of the negative electrolyte and the positive electrolyte is recycled in corresponding proportions into the positive electrolyte tank/reservoir and the negative electrolyte tank/reservoir.

A further aspect of the present invention relates to the recycling of the mixture of the positive electrolyte and of the negative electrolyte prepared in the course of steps (ii) to (iv) after and the determination of the charge state into the negative electrolyte tank and the positive electrolyte tank, and to the use of the mixture of the positive electrolyte and the negative electrolyte for rebalancing of the vanadium redox flow battery.

The long-term operation of redox flow batteries shows that various processes proceed during the charge and discharge operation, which can lead to a change in the vanadium concentration, molar amount of vanadium and/or electrolyte volume of the negative electrolyte tank and positive electrolyte tank. These changes are attributable to factors including unwanted diffusion processes and the mass transfer of vanadium ions and water through the membrane. For this reason, it is therefore appropriate to conduct rebalancing of the electrolyte at regular intervals in order to compensate or match the volume, the vanadium concentration and/or the molar amount of vanadium in the positive electrolyte and negative electrolyte, and hence to keep the capacity of the storage means constant.

Both the determination of the charge state of the positive electrolyte described within the scope of steps (ii) to (iv) and the rebalancing entail partial mixing of the negative electrolyte with the positive electrolyte. In the rebalancing operation, the negative electrolyte and the positive electrolyte are mixed with one another in order to match or compensate the volume, the vanadium concentration or the molar amount of vanadium in the two electrolytes. In the determination of the charge state of the positive electrolyte described within the scope of steps (ii) to (iv), the negative electrolyte and the positive electrolyte are mixed with one another in order to determine the vanadium concentration and the charge state of the positive electrolyte.

For the operation of the vanadium redox flow battery, it may therefore be advisable to combine the determination of the charge state and the rebalancing or remixing with one another in order to reduce the reduction in the efficiency of the vanadium redox flow battery owing to the discharge for technical reasons in the mixing of the negative electrolyte and the positive electrolyte. If required, the frequency of the determination of the charge state, the choice of the mixing ratio for the determination of the charge state and the recycling of the mixture of the negative electrolyte and the positive electrolyte can be chosen or adapted such that the mixture of the negative electrolyte and the positive electrolyte, after steps (ii) to (iv), can be used in a further step (v) for rebalancing of the electrolyte.

Depending on the frequency of the determination of the charge state and the volume used to determine the charge state, the mixture of the negative electrolyte and the positive electrolyte can be used either for complete or for partial rebalancing of the electrolyte. For rebalancing of the volume, the mixture of the negative electrolyte and the positive electrolyte, after the determination of the charge state, is preferably recycled into the electrolyte having the lower volume.

Alternatively, the mixture of the negative electrolyte and the positive electrolyte can be used for rebalancing of the molar amount of vanadium. For this purpose, the mixture of the negative electrolyte and the positive electrolyte, after the determination of the charge state, is preferably recycled into the electrolyte having the smaller molar amount of vanadium.

For rebalancing of the vanadium concentration, or in order to match the vanadium concentration in the negative electrolyte and in the positive electrolyte, the mixture of the negative electrolyte and the positive electrolyte, after the determination of the charge state, is recycled into the electrolyte having the lower vanadium concentration or into the electrolyte having a higher vanadium concentration.

In the best case, the determination of the charge state of the electrolyte or the recycling of the mixture of the negative electrolyte and the positive electrolyte is designed, or combined with the rebalancing, such that continuous rebalancing of the electrolyte is achieved and it is possible to dispense with discontinuous rebalancing at regular time intervals, as is typically implemented.

A further aspect of the present invention relates to a vanadium redox flow battery having a positive half-cell and a negative half-cell, a membrane positioned between the positive half-cell and negative half-cell, and circuits for positive and negative electrolytes, each of which comprise a reservoir for positive or negative electrolyte, a feed for the electrolyte into the respective half-cell, an outlet for the electrolyte from the half-cell into the reservoir and a pump for feeding positive and negative electrolyte into the positive and negative half-cells, wherein the vanadium redox flow battery
in the region of the feed for the electrolyte into the negative half-cell has a device for determining the UV/vis spectrum of the negative electrolyte,
in the region of the respective feeds for the positive and negative electrolytes into the negative and positive half-cells has an outlet for electrolytes, wherein the outlets are connected flush to one another and to a feed to a device for determining the UV/vis spectrum of the mixture of negative electrolyte and positive electrolyte, and
has a closed-loop control circuit designed to determine the concentrations of V²⁺, V³⁺ and V⁴⁺ from the UV/vis spectra and to calculate the concentrations of V⁴⁺ and V⁵⁺ in the positive electrolyte from the concentrations of V²⁺ and V³⁺ in the negative electrolyte and the concentrations of V²⁺, V³⁺ and V⁴⁺ in the mixture of positive electrolyte and negative electrolyte.

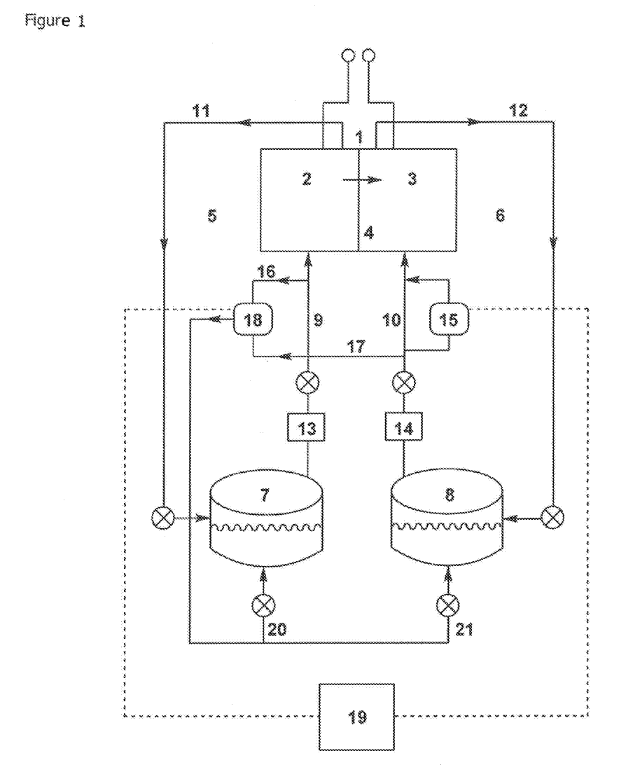

A schematic diagram of such a battery is shown in FIG. 1, in which 1 represents the redox flow cell, 2 and 3 respectively represent the positive and negative half-cells and 4 represents the membrane. By means of the pumps 13 and 14, positive and negative electrolyte is pumped out of the reservoirs 7 and 8 into the respective half-cells 2 and 3. After leaving the half-cells, the electrolyte flows through conduits 11 and 12 back into the reservoirs 7 and 8. ⊗ in each case denotes valves that are each opened during the operation of the battery, and can be closed when the battery is not being used in order to prevent processes of diffusion of the electrolytes through the conduits. 5 and 6 each represent the circuit of the positive electrolyte and negative electrolyte. In the region of the feed of the negative electrolyte 10 into the negative half-cell 3, a device for measuring the UV/vis spectrum of the negative electrolyte 15 is provided, through which electrolyte flows via a conduit parallel to the main conduit, or which may be integrated directly into the feed for the negative electrolyte 10. In addition, the device, in the region of the feed for the negative electrolyte 10, has an outlet 17 by which electrolyte can be fed to a further device for measurement of a UV/vis spectrum 18. The device 18 also has a feed for positive electrolyte which is branched off in the region of the feed for the positive electrolyte 9 to the positive half-cell 2 via outlet 16, and with which negative electrolyte coming from the outlet 17 is mixed, before the UV/vis spectrum of the mixture is recorded in the device 18. Finally, the vanadium redox flow battery has a closed-loop control circuit 19, with the aid of which the concentrations of V²⁺ and V³⁺ in the negative electrolyte and V⁴⁺ and V⁵⁺ in the positive electrolyte, and hence the charge state of the battery, can be calculated.

It will be apparent to the person skilled in the art that the battery described is not limited to the use of one redox flow cell; instead, the battery may also have multiple redox flow cells that are connected in series, for example. In this case, the outlets for positive electrolyte and negative electrolyte are appropriately in a region of the feeds 9 and 10 in which the overall electrolyte is guided to the different redox flow cells.

As stated above, the vanadium redox flow cell has a negative half-cell and a positive half-cell, and a membrane or separator positioned between the positive half-cell and the negative half-cell. The membrane is an ion-conducting membrane that assures ion exchange between the electrolytes in the positive and negative half-cells, while mixing of the two solutions that are pumped through the cells is prevented. Theoretically, the membrane should isolate the metal ions in their half-cells, but for the above reasons it is not possible to completely avoid a certain degree of ion migration through the membranes as well over time.

Preferably, the membrane is an ion exchange membrane and especially a cation exchange membrane or anion exchange membrane. A cation exchange membrane enables the transfer of charge-carrying H⁺ ions, depending on the concentration of the electrolyte. Typically, the cation exchange membrane is Nafion 112, Nafion 117 or other Nafion cation exchange membranes. However, the cation exchange membrane may also be a Gore Select membrane, a Flemion membrane or a Selenion CMV cation exchange membrane. Other suitable membranes, for example the products sold by FuMA-Tech GmbH, Germany, under the Fumatech trade name, may likewise be used, provided that they have good chemical stability in the vanadium ion-containing solutions, high electrical durability and low permeability to the vanadium ions in the electrolytes in the positive half-cell and negative half-cell.

In respect of the membrane, it may additionally be appropriate when it is covered by a graphite paper with respect to the positive half-cell and the negative half-cell, as described, for example, in U.S. Pat. No. 8,808,897.

The material of which the negative and positive electrodes for the vanadium redox flow cell consist is typically a porous carbon material or a felt, matte material or fabric material based on graphite, applied to a substrate of graphite, glassy carbon or conductive carbon. Suitable electrodes are sold, for example, under the SIGRACET® TF6 or SIGRACELL GFA3 EA trade names by SGL, Germany. The positive electrode material may likewise be an oxide-coated titanium metal plate or an expanded metal mesh. A titanium-based electrode gives longer-lasting stability to oxidation during the charging of the solution in the positive half-cell.

In order to discharge the vanadium redox flow battery, the electrodes should appropriately be connected such that electricity can flow from the negative side to the positive side of the cell through the flow of the electrons. The charging and discharging can be effected either while the pumps are switched on and the electrolytes are being pumped through the external tanks into the redox flow cell, or while the pumps are switched off, such that the solution can enter into a discharge reaction in the cell.

In order to be able to conduct electrolysis with the redox flow batteries of the invention, which serves for regeneration of protons in the negative half-cell, as described above, it is appropriate when the positive half-cell is designed as an electrolysis cell. For this purpose, it is advisable if the positive electrode is designed as a corrosion-resistant electrode. Suitable electrodes in this connection are, for example, the Diachem® “diamond” electrodes from Condias GmbH, Germany.

In addition, it is appropriate if the above-outlined vanadium redox flow battery has feeds by which the mixture of negative electrolyte and positive electrolyte can be recycled into the circuits for the positive electrolyte and the negative electrolyte. FIG. 1 shows such feeds 20 and 21 by way of example.

It was outlined above that the method of the invention can be further configured advantageously when the charge state of the negative electrolyte and positive electrolyte is conducted before and after passing through the electrolysis cell since this information can be used to draw conclusions about the charge/discharge efficiency of the cell. Appropriately, the device described here is therefore modified such that it has, in the region of the feeds 12 for the negative electrolyte out of the negative half-cell 3, a device for determination of the UV/vis spectrum of the negative electrolyte and, in the region of the outlets for the negative electrolyte and positive electrolyte 11 and 12 out of the negative half-cell and positive half-cell, outlets for these electrolytes, where the outlets are connected flush to one another and to a feed to a device for determining the UV/vis spectrum of the mixture of negative electrolyte and positive electrolyte. The mixture formed in this case too should preferably be recycled into the reservoirs 7 and 8, which is preferably effected with the aid of a feed of the mixture to the feeds 20 and 21.

As mentioned above, rebalancing can be effected wholly or partly via the feed of the mixture of positive electrolyte and negative electrolyte. If rebalancing is not possible to the degree required via this measure, additional rebalancing can also be effected via additional conduits mounted between the reservoirs 7 and 8. The conduits may be actuatable by additional pumps, but it is also possible to mount the conduits between the feed 9 and the reservoir 8 or between the feed 10 and the reservoir 7 in order thus to utilize the pump output of the pumps 13 and 14. In this case, these conduits are appropriately connected via valves to the conduits 9 and 10 which can be opened or closed as required. For this purpose, the apparatus should appropriately be modified such that it has, between the outlet 12 and the reservoir 7, or between the outlet 11 and the reservoir 8, further conduits actuatable by a separate valve or the valve represented as ⊗ in FIG. 1.

According to the above description, the improvement in the process described is that, firstly, the constants, i.e. the extinction coefficients of the various species V²⁺, V³⁺ and V⁴⁺ at the relevant wavelengths, are determined once and used for further calculations. Secondly, the charge state of the positive electrolyte is determined indirectly by prior mixture of positive electrolyte and negative electrolyte in a known ratio, using the directly determined concentration of V²⁺ and V³⁺ in the negative electrolyte as the basis for the calculation. The advantage of this process is accordingly that
(i) the concentration of the individual species can be determined exactly irrespective of the total concentration,
(ii) the extinction coefficient of a UV/vis-active species is a natural constant that has to be determined once and hence no further calibration is required,
(iii) the method can be applied to various systems, meaning that variations by stabilizers, temperature and variations in the transition metal are also possible; the method is thus applicable in a broader sense to all redox flow systems with transition metals as charge carriers,
(iv) if required, by recording the entire spectrum, it is potentially possible to ascertain contaminations by transition metals or other UV/vis-active species.

Accordingly, a further aspect of the present invention also relates to a method of determining the charge state of a redox flow battery having a negative half-cell and positive half-cell, comprising the steps of
(i) determining the charge state of the negative electrolyte by determining the concentrations of oxidized and reduced form of the redox metal via absorption at a defined wavelength,
(ii) mixing a defined volume of the negative electrolyte and the positive electrolyte,
(iii) determining the concentration of oxidized and reduced form of the redox metal from the negative electrolyte or oxidized form of the redox metal from the negative electrolyte and reduced form of the redox metal from the positive electrolyte, and
(iv) determining the charge state of the positive electrolyte by calculating the original concentration of the oxidized and reduced form of the redox metal from the positive electrolyte from the concentrations determined in steps (i) to (iii),
   and to a method of operating a redox flow battery, in which this method is used to determine the charge state of a redox flow battery. In respect of this method, the above details relating to preferred embodiments are analogously applicable, to the extent that they are meaningful.

The present invention is described in detail hereinafter by a few examples, but these are not intended to be crucial for the assessment of the scope of protection of the present invention.

### EXAMPLES

### Example 1

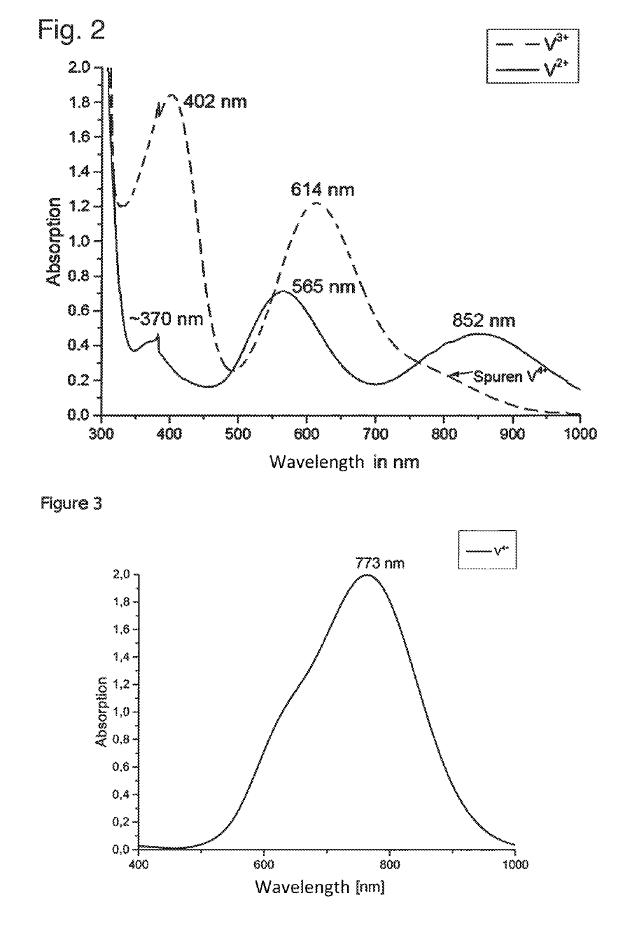

The extinction coefficients of the di-, tri- and tetravalent vanadium species that are mentioned in equations 1, 2, 4 and 5 were first estimated by means of the very substantially pure spectra of the species (see FIGS. 2 and 3).

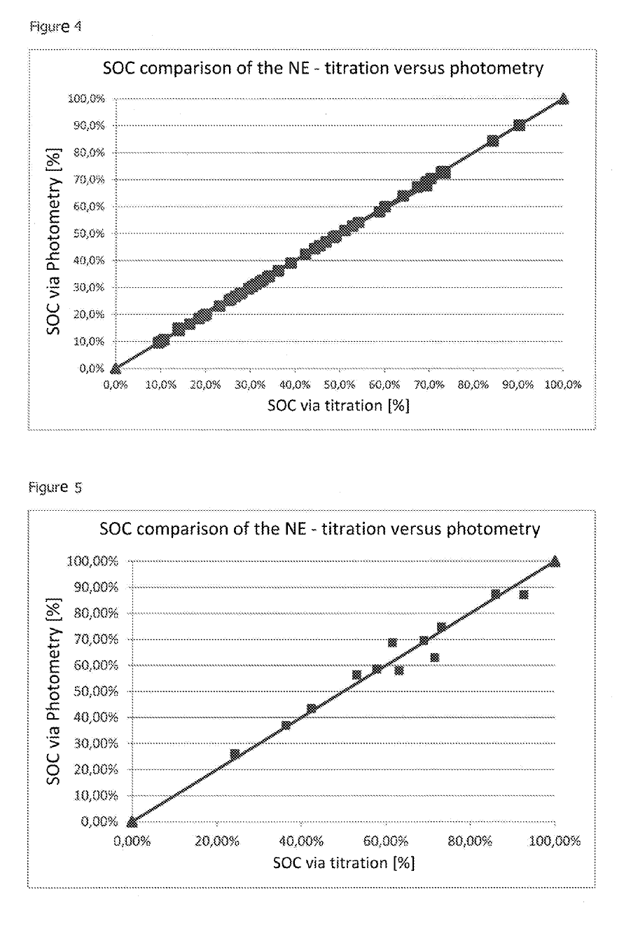

In the next step, for more exact determination of the extinction coefficients of the negative electrolyte system, using a series of real samples with different total vanadium concentrations and charge states, the exact extinction coefficients were determined by iteration (see FIG. 4). Calibration was effected via permanganometric titration, which was defined as the target value. The same approach was likewise employed for different real samples with different total vanadium concentrations and charge states and a mixing ratio of 1.5 parts positive electrolyte to 1 part negative electrolyte. Calibration was likewise effected via permanganometric titration (see FIG. 5). In FIGS. 4 and 5, ▴ indicates the target value and ▪ the photometrically determined solver values. The line connects the two target values.

The extinction coefficients thus determined by iteration are reported in table 1.

TABLE 1

| NE | | | PE | | |
|---|---|---|---|---|---|
| d (cuvette) = 0.01 cm | | | d (cuvette) = 0.01 cm | | |
| ε (V²⁺; 852 nm) | 34.36 | L * mol⁻¹ * cm⁻¹ | ε (V⁴⁺; 773 nm) | 182.77 | L * mol⁻¹ * cm⁻¹ |
| ε (V³⁺; 852 nm) | 0.53 | L * mol⁻¹ * cm⁻¹ | ε (V³⁺; 773 nm) | 0.01 | L * mol⁻¹ * cm⁻¹ |
| ε (V²⁺; 402 nm) | 6.82 | L * mol⁻¹ * cm⁻¹ | ε (V⁴⁺; 402 nm) | 8.33 | L * mol⁻¹ * cm⁻¹ |
| ε (V³⁺; 402 nm) | 138.78 | L * mol⁻¹ * cm⁻¹ | ε (V³⁺; 402 nm) | 138.14 | L * mol⁻¹ * cm⁻¹ |

It also becomes clear from the table that the extinction coefficient of the V³⁺ species at 402 nm (ε(V³+; 402 nm)), as expected, is virtually identical via both iterations.

The extinction coefficients thus ascertained were used for the examples which follow.

### Example 2

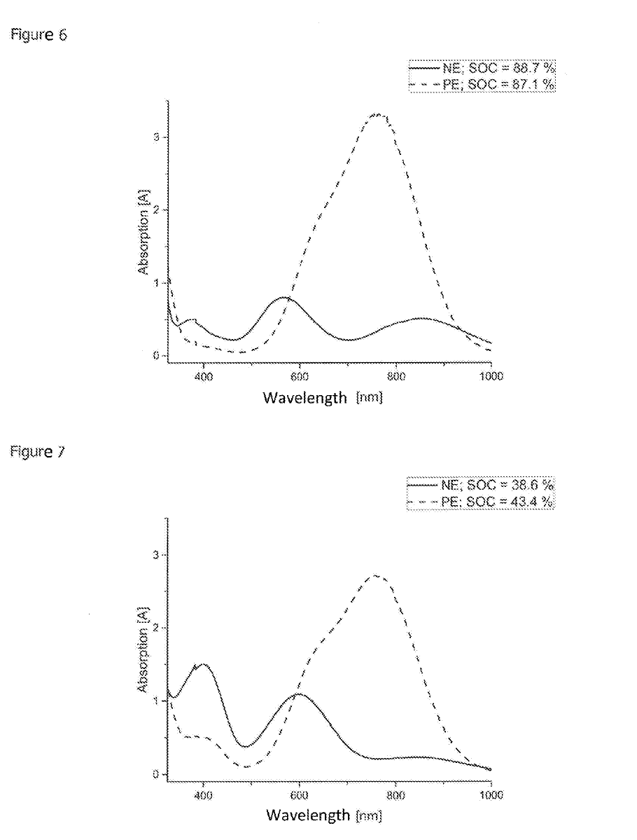

After charging a redox flow battery, the charge state and the total vanadium concentration of a negative electrolyte solution were determined by means of the UV/vis spectrum (see FIG. 6) and the above-described approach and calibrated by permanganometric titration. Subsequently, a mixture of two parts positive electrolyte of unknown concentration and charge state with one part negative electrolyte was made up. Using this mixture, the charge state and the total vanadium concentration were determined for the positive electrolyte, likewise by the above-described method, by means of UV/vis spectrum (see FIG. 6) and compared with permanganometric titration (see table 2).

TABLE 2

| | | | Vₜₒₜ | Vₜₒₜ |
|---|---|---|---|---|
| | SOC | SOC | (titration) | (photometry) |
| Unit | (titration) % | (photometry) % | mol/L | mol/L |
| | Negative electrolyte | | | |
| Example 2 | 90.2 | 88.7 | 1.73 | 1.68 |
| Example 3 | 39.1 | 38.6 | 1.74 | 1.71 |
| Example 4 | 82.5 | 79.3 | 1.66 | 1.72 |
| Example 5 | 88.0 | 87.9 | 1.33 | 1.33 |
| | Positive electrolyte | | | |
| Example 2 | 92.7 | 87.1 | 1.78 | 1.85 |
| Example 3 | 42.4 | 43.4 | 1.77 | 1.76 |
| Example 4 | 35.1 | 37.2 | 2.31 | 2.42 |
| Example 5 | 39.7 | 43.3 | 1.89 | 1.90 |

### Example 3

In the semicharged state of a redox flow battery, the charge state and the total vanadium concentration of a negative electrolyte solution were determined by means of the UV/vis spectrum (see FIG. 7) and the above-described approach and calibrated by permanganometric titration. Subsequently, a mixture of two parts positive electrolyte of unknown concentration and charge state with one part negative electrolyte was made up. Using this mixture, the charge state and the total vanadium concentration were determined for the positive electrolyte, likewise by the above-described method, by means of UV/vis spectrum (see FIG. 7) and compared with permanganometric titration (see table 3).

### Example 4

The example which follows shows that even electrolyte solutions with significantly different charge levels (caused by diffusion processes, for example) can be examined by means of this method for total vanadium concentration and charge state.

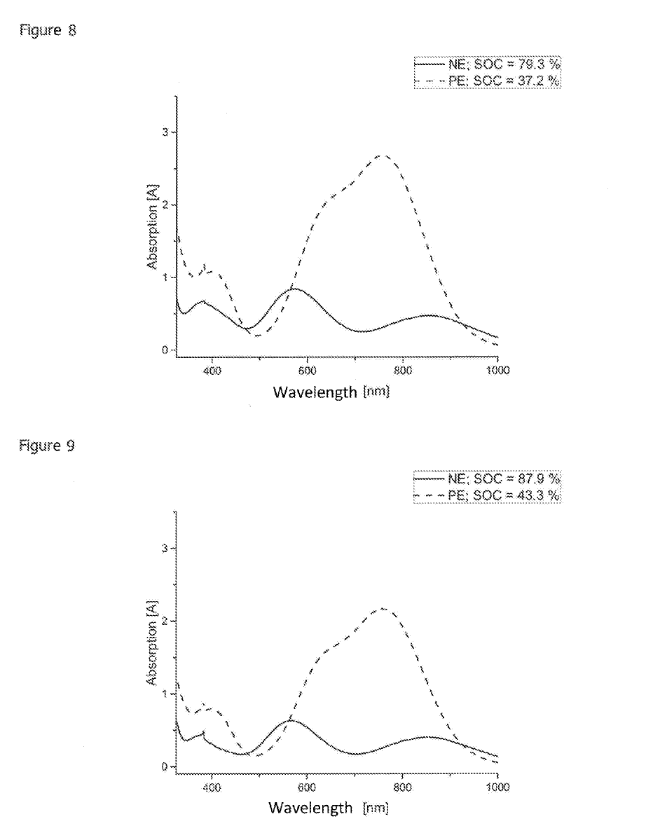

The approach was identical to the two previous examples. Only the mixing ratio between positive electrolyte and negative electrolyte was chosen as 1.5:1 in this case. The UV/vis spectra that were employed for evaluation are shown in FIG. 8 and the comparison to the permanganometric results is given in table 3.

### Example 5

In this example, the approach was identical to example 4 (mixing ratio 1.5:1; positive electrolyte to negative electrolyte). It shows that this method, in spite of distinctly different total vanadium concentrations by comparison with the previous example (but with the charge state of the half-cells comparable to example 4), is extremely reliably applicable within a broad concentration range. The spectra used for evaluation are shown in FIG. 9 and the comparison to the permanganometric results is given in table 3.

### LIST OF REFERENCE NUMERALS

1 redox flow cell
2 positive half-cell
3 negative half-cell
4 membrane
5 circuit for the positive electrolyte
6 circuit for the negative electrolyte
7 reservoir for the positive electrolyte
8 reservoir for the negative electrolyte
9 feed for the positive electrolyte to the positive half-cell
10 feed for the negative electrolyte to the negative half-cell
11 outlet for the positive electrolyte from the positive half-cell
12 outlet for the negative electrolyte from the negative half-cell
13 pump for positive electrolyte
14 pump for negative electrolyte
15 UV/vis detector
16 outlet for the positive electrolyte to UV/vis detector
17 outlet for the negative electrolyte to UV/vis detector
18 UV/vis detector
19 control circuit
20 feed to the reservoir for the positive electrolyte
21 feed to the reservoir for the negative electrolyte

1.-15. (canceled)

16. A method of determining a charge state of a redox flow cell having a negative half-cell and a positive half-cell, the method comprising steps of:
(i) determining the charge state of a negative electrolyte by determining concentrations of oxidized and reduced form of redox metal via absorption at a defined wavelength;
(ii) mixing a defined volume of the negative electrolyte and a positive electrolyte;
(iii) determining the concentrations of the oxidized and reduced form of the redox metal from the negative electrolyte or oxidized form of the redox metal from the negative electrolyte and reduced form of the redox metal from the positive electrolyte; and
(iv) determining the charge state of the positive electrolyte by calculating original concentrations of the oxidized and reduced form of the redox metal from the positive electrolyte from the concentrations determined in steps (i) and (iii).

17. The method of claim 16 wherein
step (i) comprises determining the charge state of the negative electrolyte by determining concentrations of V²⁺ and V³⁺ via absorption at a defined wavelength;
step (ii) comprises mixing the defined volume of the negative electrolyte and the positive electrolyte;
step (iii) comprises determining the concentrations of V²⁺ and V³⁺ or V³⁺ and V⁴⁺ via absorption at a defined wavelength in a mixture of the negative electrolyte and the positive electrolyte; and
step (iv) comprises determining the charge state of the positive electrolyte by calculating the original concentrations of V⁴⁺ and V⁵⁺ from the concentrations determined in steps (i) and (iii).

18. The method of claim 17 wherein the concentrations of V²⁺ are measured at a wavelength in a range from 800 to 900 nm.

19. The method of claim 17 wherein the concentrations of V³⁺ are measured at a wavelength in a range from 370 to 450 nm.

20. The method of claim 17 wherein the concentrations of V⁴⁺ are measured at a wavelength in a range from 700 to 850 nm.

21. The method of claim 17 wherein the concentrations of V²⁺ and V³⁺ ions or V³⁺ and V⁴⁺ ions are determined by correcting an absorption ascertained by an absorption component of a respective other ion.

22. The method of claim 17 wherein the charge state of the negative electrolyte is determined upstream of a feed to an electrolysis cell and in a region of an outlet from the electrolysis cell, wherein steps (ii) to (iv) are performed with the positive electrolyte and the negative electrolyte, each of which is branched off from the electrolysis cell upstream of the feed to the electrolysis cell and in the region of the outlet from the electrolysis cell.

23. The method of claim 17 wherein a mixture of the negative electrolyte and the positive electrolyte generated in step (ii) is fed in equal proportions to the negative half-cell and the positive half-cell.

24. The method of claim 17 wherein a mixture of the negative electrolyte and the positive electrolyte generated in step (ii) is fed in different proportions to the negative half-cell and the positive half-cell.

25. The method of claim 17 comprising rebalancing a redox flow battery with a mixture of the negative electrolyte and the positive electrolyte generated in step (ii).

26. The method of claim 16 configured to be calibration-free.

27. The method of claim 16 wherein step (ii) comprises mixing the negative electrolyte with the positive electrolyte in a ratio ranging from 4:1 to 1:4.

28. A vanadium redox flow battery comprising:
a positive half-cell;
a negative half-cell;
a membrane disposed between the positive half-cell and the negative half-cell;
circuits for positive electrolytes and negative electrolytes, with each circuit comprising:
a reservoir for the respective electrolytes,
a feed for feeding the respective electrolytes into one of the half-cells,
an outlet for egress of the respective electrolytes from one of the half-cells into the reservoir, and
a pump for feeding the respective electrolytes into one of the half-cells;
a device for determining a UV/vis spectrum of the negative electrolytes, wherein the device is disposed in a region of the feed for feeding the negative electrolytes into the negative half-cell;
outlets for the electrolytes disposed in a region of the feeds, wherein the outlets disposed in the region of the feeds are connected flush to one another and to a feed to a device for determining a UV/vis spectrum of a mixture of the negative electrolytes and the positive electrolytes; and
a closed-loop control circuit for determining concentrations of V²⁺, V³⁺, and V⁴⁺ from UV/vis spectra and calculating concentrations of V⁴⁺ and V⁵⁺ in the positive electrolytes from the concentrations of V²⁺ and V³⁺ in the negative electrolytes and the concentrations of V²⁺, V³⁺, and V⁴⁺ in the mixture of the negative and positive electrolytes.

29. The vanadium redox flow battery of claim 28 wherein the positive half-cell is an electrolysis cell, wherein a positive electrode is a corrosion-resistant electrode.

30. The vanadium redox flow battery of claim 28 comprising feeds by which the mixture is recyclable into the circuits for the positive and negative electrolytes.
